(19) United States
(12) Patent Application Publication
(10) Pub. No.: US 2007/0237183 A1
(43) Pub. Date: Oct. 11, 2007

(54) METHOD, SYSTEM AND STORAGE MEDIUM FOR CHANNEL CHANGING

(75) Inventor: Chih-Cheng Chang, Keelung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/616,244

(22) Filed: Dec. 26, 2006

(30) Foreign Application Priority Data
Apr. 6, 2006 (TW) TW95112107

(51) Int. Cl. H04H 1/04

(52) U.S. Cl. 370/487; 370/252

(57) ABSTRACT

A method, system and storage medium for channel changing. The method comprises the following steps: obtains a current channel number, receives an instruction to determine a channel change direction, searches a first lookup table to find a target channel number according to the direction, searches a second lookup table to get channel information of the target channel according to the target channel number, and changes from the current channel to the target channel according to the channel information.

### BACKGROUND OF THE INVENTION

### Field of the Invention

The invention relates to techniques for channels changing, and, more particularly, to changing channels in a television reception system.

A television typically comprises an apparatus for changing channels. A user may command an upward or downward instruction to change channels. A tuner in a changing channel system tunes to a desired frequency in response to the instruction. Conventionally, when changing channels, a processor in the television checks a database to determine the desired frequency, and drives the tuner to tune to the desired frequency. In regions with complicated television broadcasting systems, however, such as Europe, a large database is required. Searching a large database is inconvenient and slow.

### BRIEF SUMMARY OF THE INVENTION

Accordingly, the invention provides a method, system and storage medium for channels changing efficiently to speed channel changing.

In one aspect of the invention, the method first obtains a current channel number of a current channel. An instruction is received for determining the channel changing direction. A target channel number of a target channel is retrieved from a first lookup table according to the instruction, wherein the first lookup table stores channel numbers corresponding to each channel. Target channel information is retrieved from a second lookup table when the target channel number is not the same as the current channel number, wherein the second lookup table stores channel information corresponding to each channel. The current channel is switched to the target channel according to the target channel information.

In another aspect of the invention, a storage medium for channel changing is provided. The storage medium comprises a first lookup table and a second lookup table. The first lookup table has at least one row comprising a channel number and a flag corresponding to the channel number. The flag is set true if the channel number has been assigned to a channel. The second lookup table has at least one row comprising a channel number and a frequency corresponding to the channel number. The channel numbers in the first lookup table are associated with the channel numbers in the second lookup table.

In yet another embodiment of the invention, a system for channel changing within a frequency range is also provided. The system comprises a user interface, a memory device, a processor and a tuner. The user interface receives an instruction which indicates a channel is changed upward or downward. The memory device stores at least a first lookup table and a second lookup table. The first lookup table notes if a channel number has been assigned to a channel, while the second lookup table stores the channel number and channel information corresponding to each channel number. The processor obtains a current channel number of a current number, retrieves a target channel number from the first lookup table according to the current channel number and the instruction, and retrieves the target channel information from the second lookup table according to the target channel number. The tuner changes the channel from the current channel to the target channel according to the target channel information.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows a block diagram of a system for channel changing according to an embodiment of the invention;

FIG. 2a shows an exemplary structure of the first and second lookup tables;

FIG. 2b shows an exemplary initialized valid channel table;

FIG. 2c shows an exemplary initialized channel number table;

FIG. 2d shows an exemplary initialized channel configuration table;

FIG. 3 shows another exemplary structure of the first and second lookup tables; and

FIG. 4 shows a flowchart of a method for channel changing according to an embodiment of the invention.

### DETAILED DESCRIPTION OF THE INVENTION

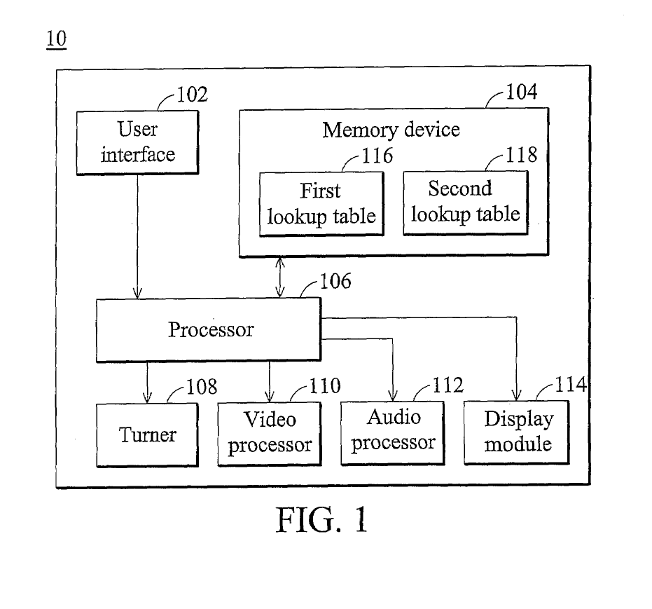

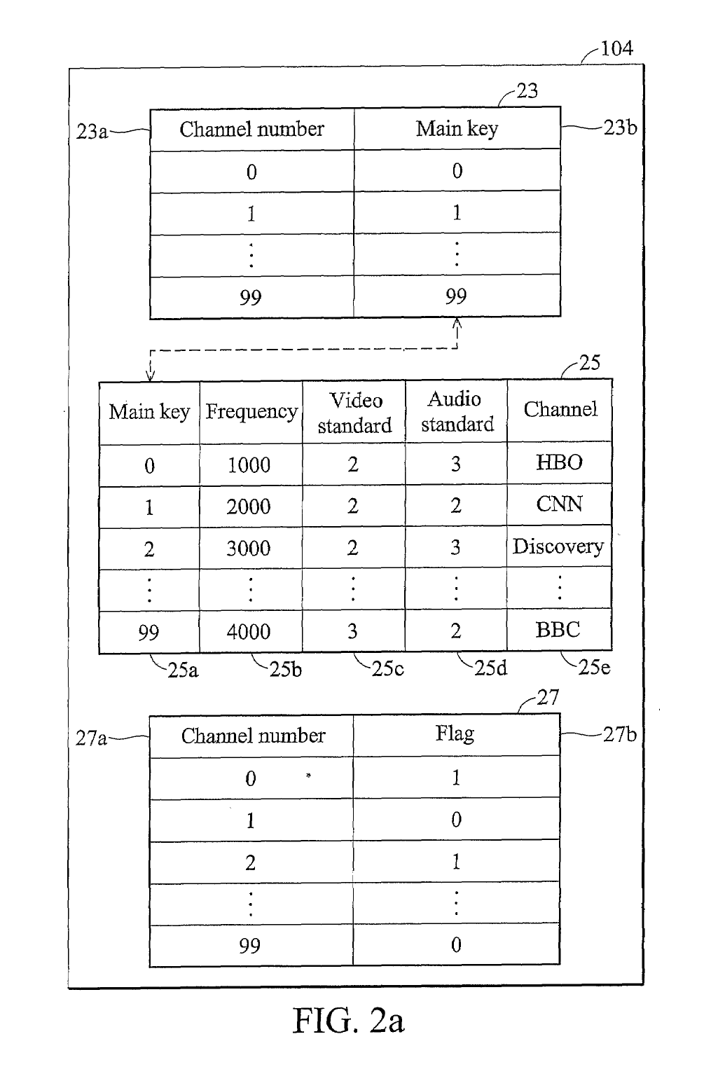

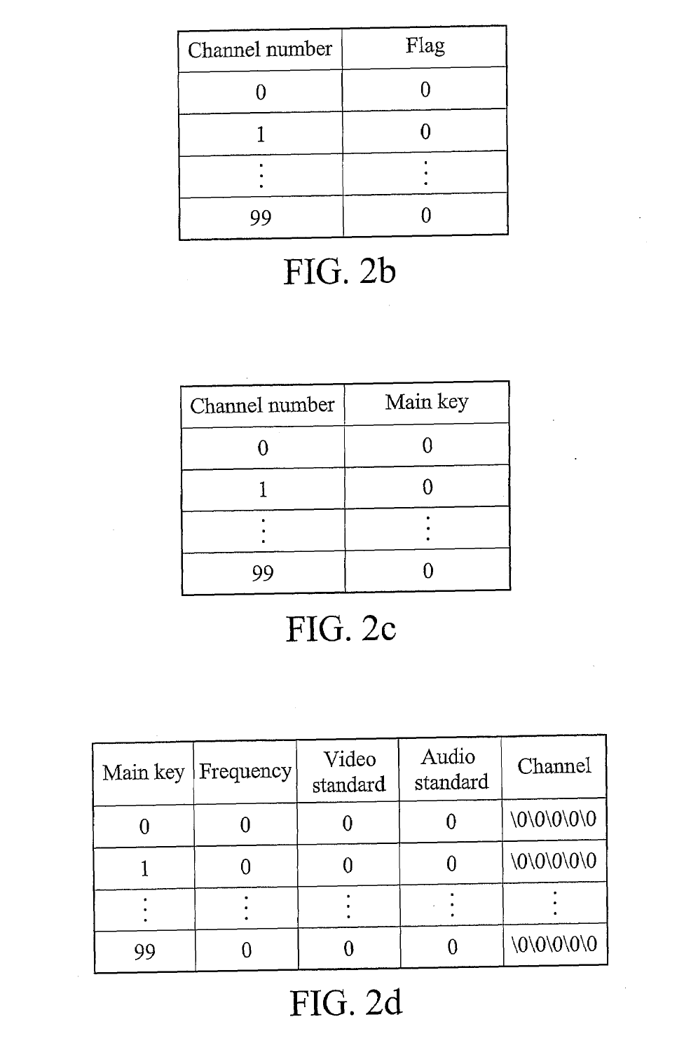

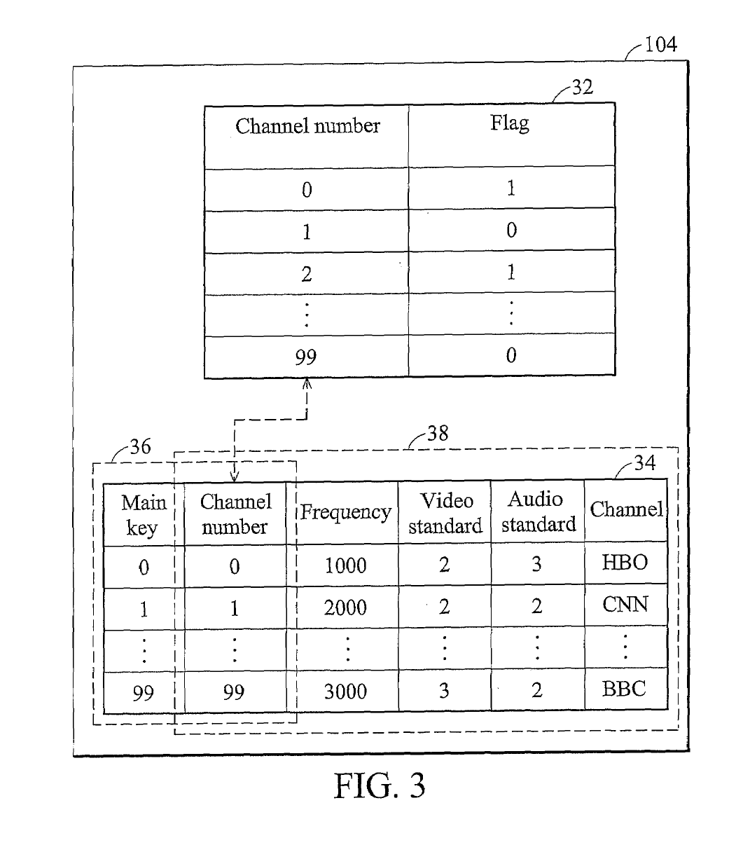

FIG. 1 shows a block diagram of a system for channel changing according to an embodiment of the invention. The system for channel changing 10 comprises a user interface 102, a memory device 104, a processor 106, a tuner 108, a video processor 110, an audio processor 112 and a display module 114. The user interface 102 receives instructions for determining the direction of the channel changing. For example, when watching channel 4, a user may issue an upward channel changing instruction to switch to channel 5, or issue a downward channel changing instruction to switch to channel 3. The channel remains unchanged when the current channel is the top or lowest channel. The memory device 104 has a first lookup table 116 and a second lookup table 118, both storing information about channels. The first lookup table 116 has at least one row comprising a channel number and a flag corresponding to the channel number. The flag is set to true if the channel number has been assigned to a channel. The second lookup table 118 has at least one row comprising the channel number and channel information corresponding to the channel number, which includes channel frequencies, video standard, and audio standard. The channel numbers in the first lookup table 116 are associated with the channel numbers in the second lookup table 118. The contents and structure of the first lookup table 116 and the second lookup table 118 will be introduced in FIG. 2a and FIG. 3. The processor 106 obtains a current channel number, and finds the next channel based on the first lookup table 116 and the current channel number. The tuner 108 tunes to a desired frequency according to the channel information retrieved from the second lookup table 118. The video processor 110 and audio processor 112 are respectively set according to the video standard and the audio standard of channel information for each channel. The display module 114 displays the channel contents.

FIG. 3 shows an exemplary structure of the first and second lookup tables. The first lookup table 32 comprises at least one row having a channel number and a flag corresponding to the channel number, wherein the flag is set to true or logic high if the channel number has been assigned to a channel. The flag indicates whether or not a channel number has been assigned to a channel. For example, an entry of channel number column in “1” with a flag corresponding to the channel number “true” means channel 1 has recorded in the valid channel table 32. To the contrary, an entry of a channel number in “1” with a flag corresponding to the channel number “false” means that channel 1 does not exist temporarily. According to the first lookup table 32 shown in FIG. 3, a user who is watching channel 0 and commands an upward channel changing will eventually watch channel 2 instead of channel 1. Because the flag of channel 1 is false, channel 1 is not recognized, thus, the processor 106 in FIG. 1 skips channel 1 and retrieves the channel number “2”. Each row of the first lookup table has only two entries, and thus, it takes less time to search the first lookup table 32.

In some preferred embodiments of the invention, the first table 32 stores several rows when initialized. The flag of each corresponding channel number is set to 0.

The second lookup table 34 comprises a plurality of rows, wherein each row includes a main key as well as a corresponding channel number, frequency, video standard, audio standard, and channel name. The channel numbers in the first and second lookup tables are associated with each other. The corresponding frequency stores an arbitrary value from 0 to 65,535 representing a certain frequency when two bytes are allocated to store the frequency. The video standard entry stores an arbitrary value from 0 to 3 representing the video standard corresponding to the main key. The audio standard entry stores an arbitrary value from 0 to 15 representing the audio standard corresponding to the main key. For example, a video standard entry storing “1”, “2” or “3” may represent NTSC (National TV Standards Committee), PAL (Phase Alternating Line), and SECAM (SEquential Couleur Avec Memoire), respectively. An audio standard entry storing “1”, “2”, or “3” may represent BG, DK, and I audio standards, respectively. The main key entry can be used as a foreign key for associating the second lookup table 34 with other lookup tables. In some preferred embodiments of the invention, the second lookup table 34 is initialized with certain rows, such as 100 rows, having main keys set from 0 to 99, frequencies, video standards and audio standards set “0”, and channel names set “\0\0\0\0\0”, Null, or N/A.

FIG. 2a shows another exemplary structure of the first and second lookup tables. The first lookup table 32 is shown as the valid channel table 27. The second lookup table 34 is split into two sub-tables, the channel configuration table 25 and the channel number table 23 so as to save searching time under certain circumstances.

FIG. 2b shows an exemplary initialized valid channel table. The initialized valid channel table comprises 100 rows, the entries in the channel number column ranks from 0 to 99, and flags corresponding to the channel numbers are set to false. The channel number table 23 in FIG. 2a comprises a plurality of rows, wherein each row has a channel number 23a and a corresponding main key 23b. The main key entry 23b can be used as a foreign key for associating the channel number table 23 with other lookup tables. In some embodiments of the invention, the channel number table 23 can be initialized with several rows, with every channel number 23a set to the row order in the channel number table 23 and every corresponding main key 23b set to “0”. FIG. 2c shows an exemplary initialized channel number table 23. The channel numbers are initialized from 0 to 99, and the corresponding main keys are set “0”.

The channel configuration table 25 in FIG. 2a comprises a plurality of rows having a main key 25a and corresponding frequency 25b, a video standard 25c, an audio standard 25d, and channel name 25e. The frequency column 25b can store an arbitrary value from 0 to 65,535 to represent a certain frequency when two bytes are allocated for the frequency column 25b. The video standard column 25c can store an arbitrary value from 0 to 3 representing the video standard corresponding to the main key. The audio standard column 25d stores an arbitrary value from 0 to 15 representing the audio standard corresponding to the main key. For example, an entry of video standard storing “1”, “2” or “3” may represent NTSC (National TV Standards Committee), PAL (Phase Alternating Line), and SECAM (SEquential Couleur Avec Memoire), respectively. An audio standard entry storing “1”, “2”, or “3” may represent BG, DK, and I audio standards, respectively. The main keys 25a of channel configuration table 25 are associated with the main keys 23b of channel number table 23. For example, a channel number “1” and the corresponding main key “1” in channel number table 23 indicates channel 1 are associated with a main key 1. Thus, the frequency corresponding to main key 1 in channel configuration table 25 notes the frequency of channel 1. In some embodiments of the invention, the channel configuration table 25 is initialized with certain rows, and the main key column 25a is set to the row order in the channel configuration table 25, the frequency column 25b, video standard column 25c and audio standard column 25d are set to “0”. All entries in the channel name column 25e are set to “\0\0\0\0\0”, Null, or N/A. FIG. 2d shows an exemplary initialized channel configuration table. The initialized channel configuration table comprises 100 rows, the main key column is ranked from 0 to 99, the frequency column, video standard and the audio standard are set 0, and the channel name column is set to \0\0\0\0\0.

The initialized channel number table 23, channel configuration table 25 and valid channel table 27 can be updated by users when the users are watching televisions. For example, a user tunes the tuner 108 and finds there is a channel at frequency 1000. The user may decide to add the channel into the channel number table 23, channel configuration table 25 and valid channel table 27. That is, the user may update the channel in the channel number table 23, channel configuration table 25 and valid channel table 27 according to a newly found channel. Table-updating methods are in themselves well known, and hence, they are not discussed in the specification.

FIG. 2d shows an exemplary initialized channel configuration table. The initialized channel configuration table comprises 100 rows, the main key column is ranking from 0 to 99, the frequency column, video standard and the audio standard are set to 0, and the channel name column is set to \0\0\0\0\0.

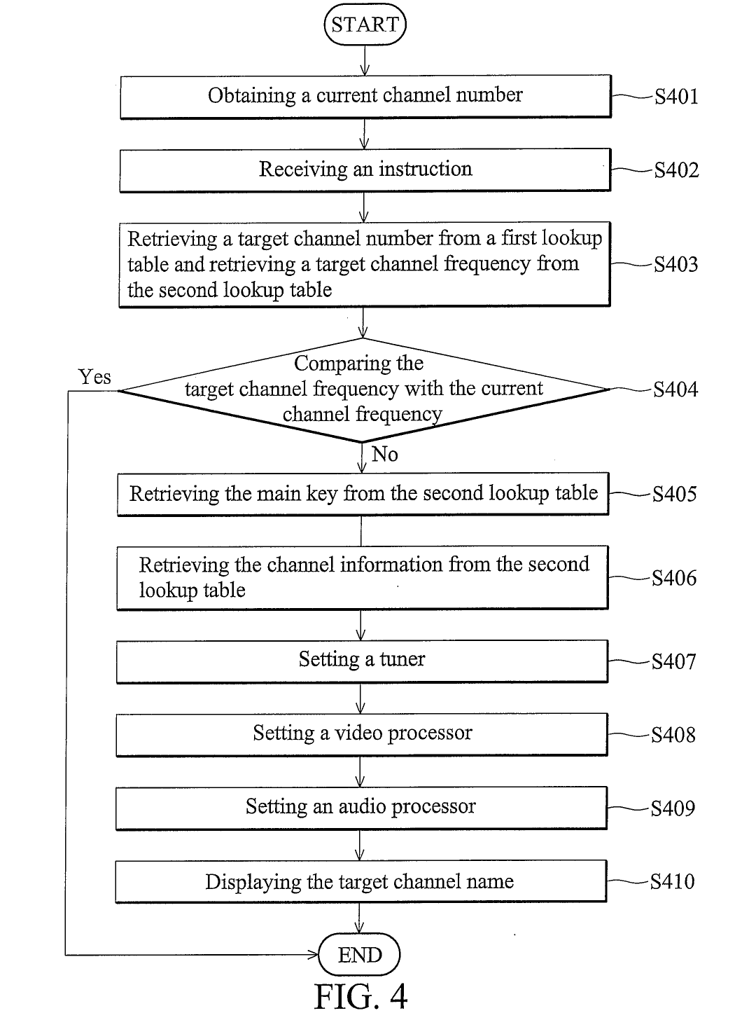

FIG. 4 shows a flowchart of a method for channel changing according to an embodiment of the invention. First, the channel number is obtained in step S401. An instruction is received in step S402 to determine the direction of the channel changing. For example, the instruction is an upward channel changing instruction or a downward channel changing instruction. In step S403, a next channel number is retrieved from the first lookup table 32 (i.e. valid channel table 27). A target channel frequency is also retrieved and is tuned by a tuner. For example, referring to FIG. 2a and FIG. 3, suppose that the current channel is channel 0, when receiving an upward channel change instruction, a valid upward channel, according to the first lookup table 32, is channel 2. In step S404, the target channel frequency is compared with the current channel frequency. If the current channel frequency is the same as the target channel frequency, mainly because the current channel is the only channel in the frequency range, the method ends. Otherwise, the main key of the target channel is retrieved in step S405. The channel name, frequency, video standard and audio standard can also be accessed from the second lookup table 38 (i.e. the channel configuration table 25 and the channel number table 23) in step S406. A video processor and audio processor can be set according to the video standard and audio standard in steps S407-S409. The channel name is shown by a display module in step S410.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for channel changing within a frequency range, wherein at least one channel exists in the frequency range, and each channel corresponds to one channel number and channel information, the method comprising:
(a) obtaining a current channel number of a current channel;
(b) receiving an instruction to determine a channel changing direction;
(c) retrieving a target channel number of a target channel from a first lookup table according to the instruction, wherein the first lookup table stores the channel number corresponding to each channel;
(d) retrieving the channel information of the target channel from a second lookup table when the target channel number is not as same as the current channel number, wherein the second lookup table comprises the channel information corresponding to each channel; and
(e) changing from the current channel to the target channel according to the channel information of the target channel.

2. The method for channel changing as claimed in claim 1, wherein the channel changing direction in step (b) is one of an upward direction and a downward direction.

3. The method for changing channel as claimed in claim 1, further comprising completing the method when the target channel is the same as the current channel in step (d).

4. The method for changing channel as claimed in claim 1, wherein the channel information comprises a frequency corresponding to the channel, and changing to the target channel in step (e) is according to the frequency corresponding to the target channel.

5. The method for channel changing as claimed in claim 1, wherein the channel information comprises a video standard, and changing to the target channel in step (e) further comprises accessing a video signal of the target channel according to the video standard corresponding to the target channel.

6. The method for channel changing as claimed in claim 5, wherein the channel information comprises an audio standard, and changing the target channel in step (e) further comprises accessing an audio signal of the target channel according to the audio standard corresponding to the target channel.

7. The method for channel changing as claimed in claim 6, further comprising:
(f) displaying the target channel according to the audio signal and the video signal.

8. The method for channel changing as claimed in claim 7, further comprising:
(f) displaying the channel information corresponding to the target channel.

9. A storage medium storing a plurality of lookup tables for channel changing, comprising:
a first lookup table having at least one row comprising a channel number and a flag corresponding to the channel number, wherein the flag is set to true if the channel number has been assigned to a channel; and
a second lookup table having at least one row comprising the channel number and a frequency corresponding to the channel number, wherein the channel number in the first lookup table is associated with the channel number in the second lookup table.

10. The storage medium as claimed in claim 9, wherein the second lookup table comprises a first sub-table and a second sub-table, the first sub-table comprises at least one row having the channel number and a main key corresponding to the channel number, the second sub-table comprises at least one row having the main key and the frequency corresponding to the main key, and the main key in the first sub-table and the main key in the second sub-table are associated with each other.

11. The storage medium as claimed in claim 9, wherein the row in the second lookup table further comprises a video standard entry and an audio standard entry for storing a video standard and a audio standard, respectively, corresponding to the channel number.

12. A system for channel changing within a frequency range, wherein at least one channel exists in the frequency range, and the channel corresponds to a channel number and channel information, the system comprising:
a user interface receiving an instruction, wherein the instruction is an upward channel change or a downward channel change;
a memory device at least storing:
a first lookup table indicating whether the channel number has been assigned to the channel; and
a second lookup table storing the channel information of the channel;
a processor obtaining the channel number of a current channel, retrieving the channel number of a target channel from the first lookup table according to the channel number of the current channel and the instruction, and retrieving the channel information of the target channel from the second lookup table according to the channel number of the target channel; and
a tuner changing the channel from the current channel to the target channel.

13. The system for channel changing as claimed in claim 12, wherein the first lookup table comprises at least one row comprising the channel number and a flag corresponding to the channel number, and the second lookup table comprises at least one row comprising the channel number and a frequency corresponding to the channel number, wherein the channel number in the first lookup table is associated with the channel number in the second lookup table.

14. The system for channel changing as claimed in claim 13, wherein the second lookup table comprises a first sub-table and a second sub-table, the first sub-table comprises at least one row having the channel number and a main key corresponding to the channel number, the second sub-table comprises at least one row having the main key and a frequency corresponding to the main key, and the main key in the first sub-table and the main key in the second sub-table are associated with each other.

15. The system for channel changing as claimed in claim 12, wherein the channel information comprises a frequency, and the tuner tunes to the target channel from the current channel according to the frequency corresponding to the target channel.

16. The system for channel changing as claimed in claim 12 further comprising a video processor, wherein the channel information comprises a video standard, the processor sets the video processor according the video standard corresponding to the target channel, and the video processor accesses a video signal of the target channel.

17. The system for channel changing as claimed in claim 16 further comprising an audio processor, wherein the channel information comprises an audio processor, the processor sets the audio processor according to the audio standard corresponding to the target channel, and the audio processor accesses an audio signal of the target channel.

18. The system for channel changing as claimed in claim 17 further comprising a display module for displaying the target channel according to the video and the audio signals corresponding to the target channel.

19. The system for channel changing as claimed in claim 18, wherein the processor transmits the channel information corresponding to the target channel to the display module, and the display module displays the channel information corresponding to the target channel.
